(19) United States
(12) Patent Application Publication
(10) Pub. No.: US 2014/0308586 A1
(43) Pub. Date: Oct. 16, 2014

(54) Negative Electrode for Lithium Ion Rechargeable Battery and Manufacturing Method Thereof

(71) Applicant: Chung-Shan Institute of Science and Technology, Longtan Township (TW)

(72) Inventors: Ching-Jang Lin, New Taipei City (TW); Biing-Jyh Weng, Longtan Township (TW); Bi-Sheng Jang, Longtan Township (TW); Jin-Tarng Hwang, Longtan Township (TW); Chuen-Ming Gee, Longtan Township (TW)

(21) Appl. No.: 13/906,279

(22) Filed: May 30, 2013

(30) Foreign Application Priority Data
Apr. 12, 2013 (TW) 102113123

(51) Int. Cl. H01M 4/583; H01M 4/04

(52) U.S. Cl. CPC H01M 4/583; H01M 4/0404; H01M 4/0471; H01M 4/0492
USPC 429/231.8; 29/623.5

(57) ABSTRACT

The present invention relates to a negative electrode for lithium ion rechargeable battery and a manufacturing method thereof. The negative electrode comprises at least one vermicular graphite and at least one pitch, wherein the vermicular graphite is fabricated by way of thermally treating an expandable graphite powder, and the pitch is adsorbed in the pores of the vermicular graphite. In the present invention, the pitch adsorbed in the vermicular graphite would be carbonized and graphitized, such that a composite graphite having multi-layer flake graphite is formed, and the composite graphite is further pulverized to a composite graphite powder. Moreover, the manufacturing method of the present invention can be used for fabricating the negative electrode for lithium ion rechargeable battery under the conditions of reducing manufacturing cost and solvent usage, so as to protect the environment from the manufacturing process pollution.

### BACKGROUND OF THE INVENTION

1. Field of the Invention

The present invention relates to a negative electrode, and more particularly to a negative electrode for lithium ion rechargeable battery and a manufacturing method thereof, wherein the manufacturing method can be used for fabricating the negative electrode of lithium ion rechargeable battery with high electrical capacitance, high coulombic efficiency, and long-time stability by low manufacturing cost.

2. Description of the Prior Art

With the development of science and technology, the 3C (computer, communication and consumer electronics) products are more and more popular, such as mobile phone, smart phone, personal computer (PC), tablet PC, etc. Nowadays, besides the 3C products, electric vehicles, smart grid, cloud computing technologies, and the electrical energy produced by the solar and the wind does also need a lithium-ion secondary battery for storing the electrical energy. Therefore, the market of the lithium ion rechargeable battery shows an obvious increasing trend because both the electrical energy storage and electrical energy supply are highly dependent on the lithium ion rechargeable battery. In general, the manufacturing materials for a negative electrode of the lithium ion rechargeable battery at least consist of carbon materials, oxides, nitrides, alloys, and nano-composites, wherein the carbon materials are currently major material for manufacturing the negative electrode. The carbon materials include coke, carbon fiber, mesocarbon microbeads (MCMBs), natural graphite, artificial graphite, and amorphous carbon, in which the MCMBs are the best carbon material.

However, there are still two shortcomings by using the MCMBs as the material for manufacturing the negative electrode of the lithium-ion rechargeable battery, the shortcomings are listed in follows: (1) the average capacitance of the negative electrode made of the MCMBs is about 330 mAh/g; such average capacitance still needs to be improved and increased; and (2) the manufacturing cost of the MCMBs is very high, moreover, a large amount of solvents must be used in MCMBs manufacturing process, and the solvents would cause pollution on human environment.

Therefore, it becomes a very important issue to reduce the manufacturing cost of the negative electrode of the lithium-ion rechargeable battery and the pollution produced by the MCMBs manufacturing process. Accordingly, in view of the conventional negative electrode manufacturing method still has shortcomings and drawbacks, the inventor of the present application has made great efforts to make inventive research thereon and eventually provided a negative electrode for lithium ion rechargeable battery and a manufacturing method thereof.

### SUMMARY OF THE INVENTION

The primary objective of the present invention is to provide a negative electrode for a lithium ion rechargeable battery, in which a vermicular graphite with high electrical conductivity and oil absorption is taken as the material for making the negative electrode of the lithium ion rechargeable battery, so as to increase the capacitance of the negative electrode.

Accordingly, to achieve the primary objective of the present invention, the inventor of the present invention provides a negative electrode for lithium ion rechargeable battery, comprising: at least one vermicular graphite, being fabricated by way of thermally treating an expandable graphite powder; and at least one pitch, being adsorbed within the pores of the vermicular graphite. Wherein the pitch adsorbed in the vermicular graphite would be carbonized and graphitized, such that a composite graphite having multi-layer flake graphite is formed, and the composite graphite is further pulverized to a composite graphite powder.

The another objective of the present invention is to provide a method for manufacturing a negative electrode for a lithium ion rechargeable battery, and the manufacturing method be used for fabricating the negative electrode of the lithium ion rechargeable battery under the conditions of reducing manufacturing cost and solvent usage, therefore the environment can be protect from the manufacturing process pollution.

So that, in order to achieve the second objective of the present invention, the inventor of the present invention provides a method for manufacturing a negative electrode for lithium ion rechargeable battery, comprising the steps of:
(1) fabricating a composite graphite powder, and then sieving the composite graphite powder;
(2) uniformly mixing the sieved composite graphite powder and a conductive carbon for making a mixed powder;
(3) evenly mixing an adhesive and a solvent for fabricating a mixed solution;
(4) adding the mixed solution into the mixed powder for forming a slurry, wherein there has a specific ratio between the mixed solution and the mixed powder;
(5) coating the slurry onto a collector plate, and disposing the collector plate into a vacuum oven for executing a vacuum drying process;
(6) treating a laminating process to the collector plate;
(7) further processing the collector plate, so as to produce an electrode with appropriate size and weight; and
(8) assembling a half-cell electrode by using the electrode.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein::

FIG. 1 is a flowchart of a method for manufacturing a negative electrode for lithium ion rechargeable battery according to the present invention;

FIG. 2 is a detailed flowchart of step (S01) of the manufacturing method;

FIG. 3 is a detailed flowchart of step (S05) of the manufacturing method;

FIG. 4 is a plot of voltage v.s. capacitance of the negative electrode for lithium ion rechargeable battery;

FIG. 5 is a plot of capacitance v.s. charge/discharge cycling time of the negative electrode for lithium ion rechargeable battery;

FIG. 6 is a plot of voltage versus capacitance of the conventional MCMBs for lithium ion rechargeable battery; and

FIG. 7 is a plot of capacitance versus charge/discharge cycling time of the conventional MCMBs for lithium ion rechargeable battery.

### DETAILED DESCRIPTION OF THE PREFERRED EMBODIMENTS

To more clearly describe a negative electrode for lithium ion rechargeable battery and a manufacturing method thereof according to the present invention, embodiments of the present invention will be described in detail with reference to the attached drawings hereinafter.

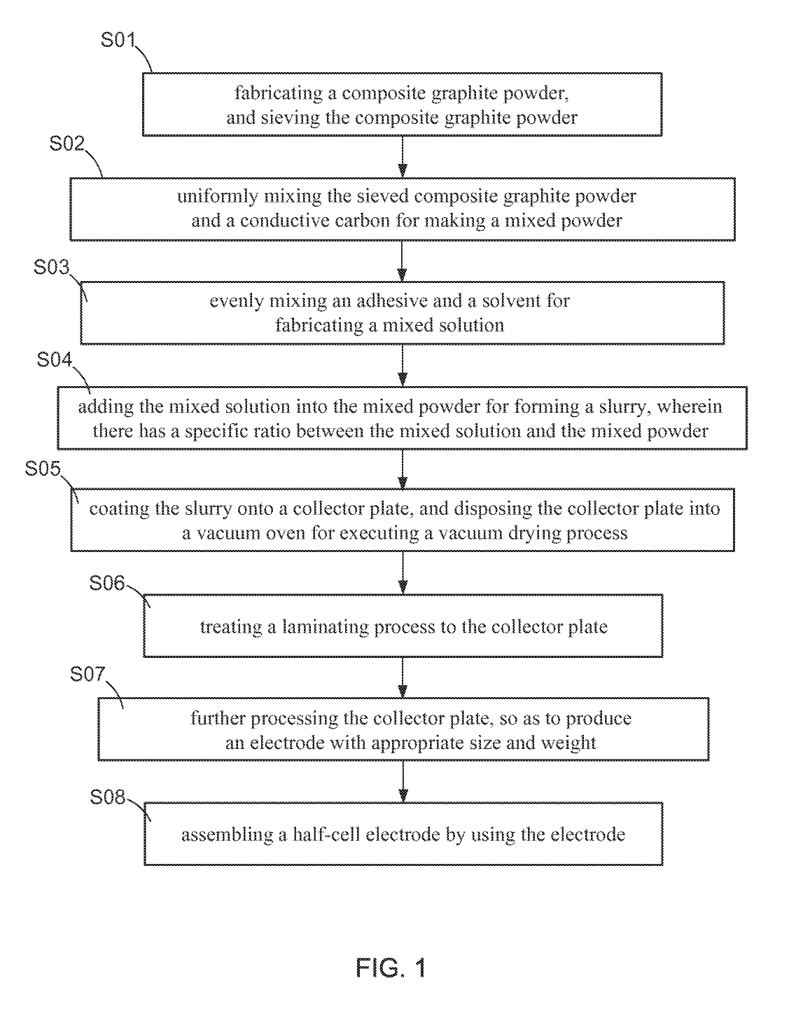

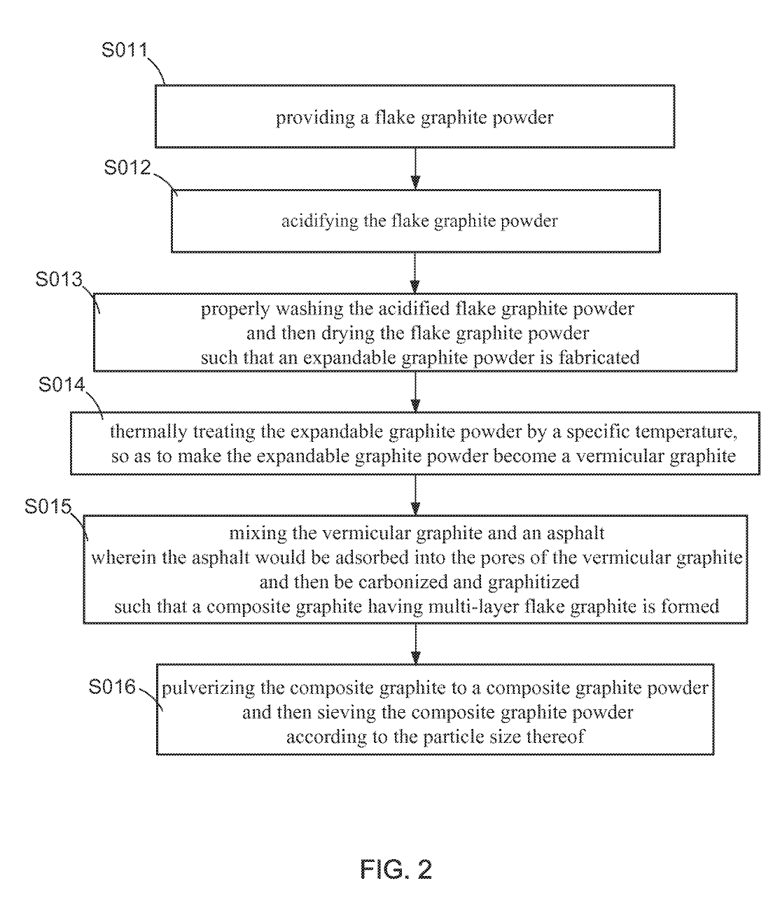

Referring to FIG. 1, there is shown a flowchart of a method for manufacturing a negative electrode for lithium ion rechargeable battery according to the present invention; moreover, please simultaneously refer to FIG. 2, which illustrates a detailed flowchart of step (S01) of the manufacturing method. As shown in FIG. 1, the manufacturing method includes following steps:

Firstly, the method proceeds to step (S01) for fabricating a composite graphite powder and sieving the composite graphite powder. In the present invention, as shown in FIG. 2, the step (S01) further includes 6 detailed steps. When executing the step (S01), it is firstly proceeded to step (S011) and step (S012), so as to provide a flake graphite powder and acidify the flake graphite powder. Next, step (S013) is proceeded for properly washing the acidified flake graphite powder and then drying the flake graphite powder, such that an expandable graphite powder is fabricated. Subsequently, the step flow is proceeded to step (S014), so as to thermally treat the expandable graphite powder by a specific temperature ranged between 700-deg C. and 1000-deg C., therefore the expandable graphite powder is made to a vermicular graphite.

Moreover, in step (S015), the vermicular graphite and a pitch are mixed for making the pitch be absorbed into the pores of the vermicular graphite, therefore the pitch would be carbonized and graphitized and then a composite graphite having multi-layer flake graphite is formed. Eventually, for completing the step (S01), the step (S016) is executed in order to pulverize the composite graphite to a composite graphite powder, and then sieve the composite graphite powder according to the particle size thereof. Herein, it needs to further explain that the pitch used in the step (S015) could be a petroleum pitch, an A240 petroleum pitch, a coal tar pitch, or an impregnation pitch, and the pitch is adsorbed in the pores of the vermicular graphite by a high-temperature liquid state. In addition, the weight percentage of the vermicular graphite in the composite graphite is ranged between 0.1 wt % and 10 wt %.

Referring to FIG. 1 again, steps (S02)˜(S05) are then executed after the step (S01) is finished. In steps (S02) and (S03), it uniformly mixes the sieved composite graphite powder and a conductive carbon for making a mixed powder, and then a mixed solution is fabricated by way of evenly mixing an adhesive and a solvent. Next, the manufacturing method of the present invention is proceeded to step (S04), so as to add the mixed solution into the mixed powder for forming a slurry, wherein there has a specific ratio between the mixed solution and the mixed powder. Therefore, in step (S05), the slurry is coated onto a collector plate, and the collector plate with the coated slurry is then disposed into a vacuum oven for executing a vacuum drying process.

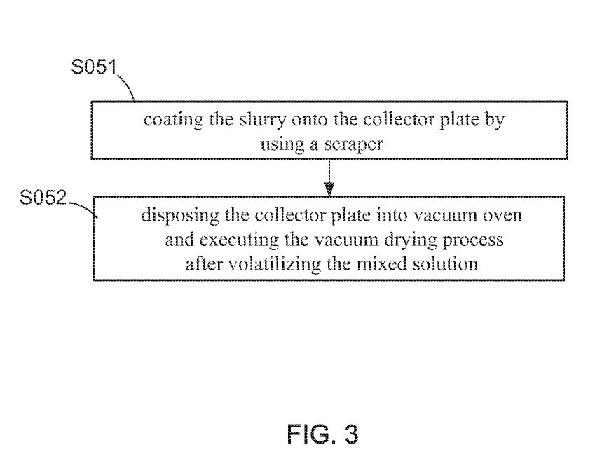

Please refer to FIG. 3, there is shown a detailed flowchart of the step (S05). As shown in FIG. 3, the step (S05) includes 2 detailed steps, i.e., step (S051) and step (S052), which are executed for coating the slurry onto the collector plate by using a scraper, and disposing the collector plate into vacuum oven, so as to execute the vacuum drying process after volatilizing the mixed solution.

Referring to FIG. 1 again, in the manufacturing method of the present invention, steps (S06)˜S(08) are next executed after the step (S05) is carried out. In the step (S06), a laminating process is treated to the collector plate; therefore the collector plate is further processed and made to an electrode with appropriate size and weight in the step (S07). Eventually, a half-cell electrode having high electrical capacitance, high coulombic efficiency, and long-time stability is assembled by using the electrode obtained from the step (S07). Herein, it needs to further explain that the laminating rate of the laminating process in the step (S06) is 75%, and an electrolyte used in the step (S08) is a lithium hexafluorophosphate (LiPF6) of 1.0 M, and the LiPF₆ is dissolved in a solution consisting of a ethylene carbonate, a polycarbonate and a dimethyl carbonate, wherein the weight percent ratio of the ethylene carbonate, the polycarbonate and the dimethyl carbonate is 1:1:1.

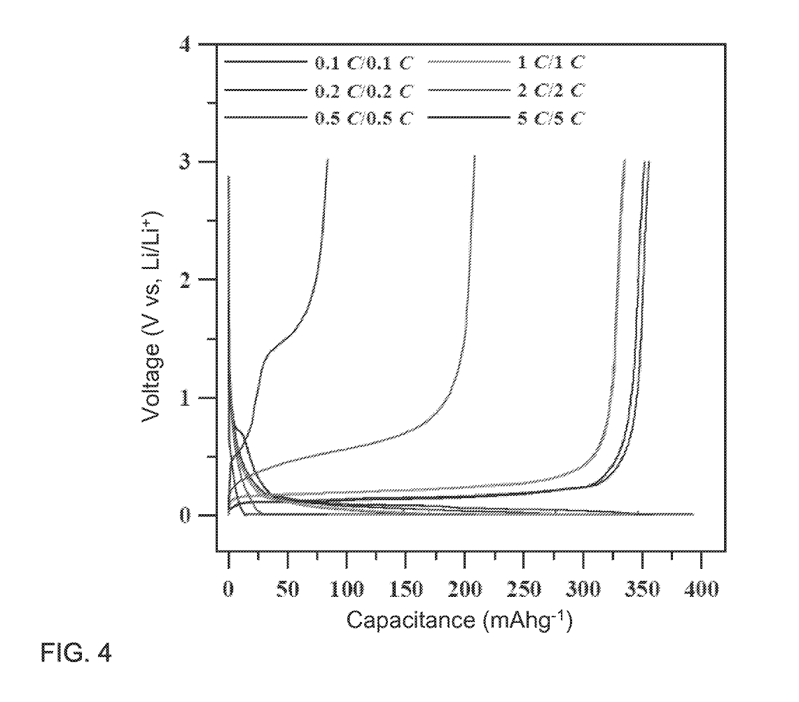

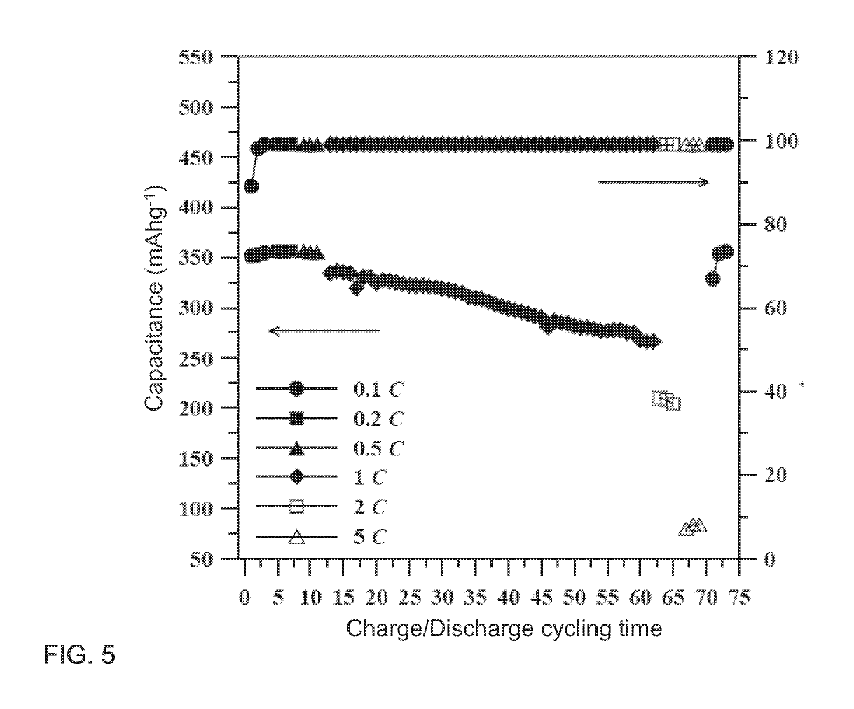

Therefore, through above method steps, the negative electrode for lithium ion rechargeable battery is fabricated. Next, a variety of experiment data will be presented for proving that the capacitance characteristic of negative electrode for lithium ion rechargeable battery is better than the conventional mesocarbon microbeads (MCMBs). Please refer to FIG. 4 and FIG. 5, which respectively show a plot of voltage v.s. capacitance and a plot of capacitance v.s. charge/discharge cycling time of the negative electrode for lithium ion rechargeable battery. Moreover, the critical experiment data of FIG. 4 and FIG .5 are further listed in following Table 1.

TABLE 1

| | capacitance | coulombic efficiency |
|---|---|---|
| charge/discharge rate | (mAhg−1) | i. (%) |
| 0.1 | 351.73 | 89 |
| 0.2 | 356.15 | 99 |
| 0.5 | 355 | 99 |
| 1 | 334.61 | 99 |
| 2 | 210 | 99 |
| 5 | 80 | 99 |

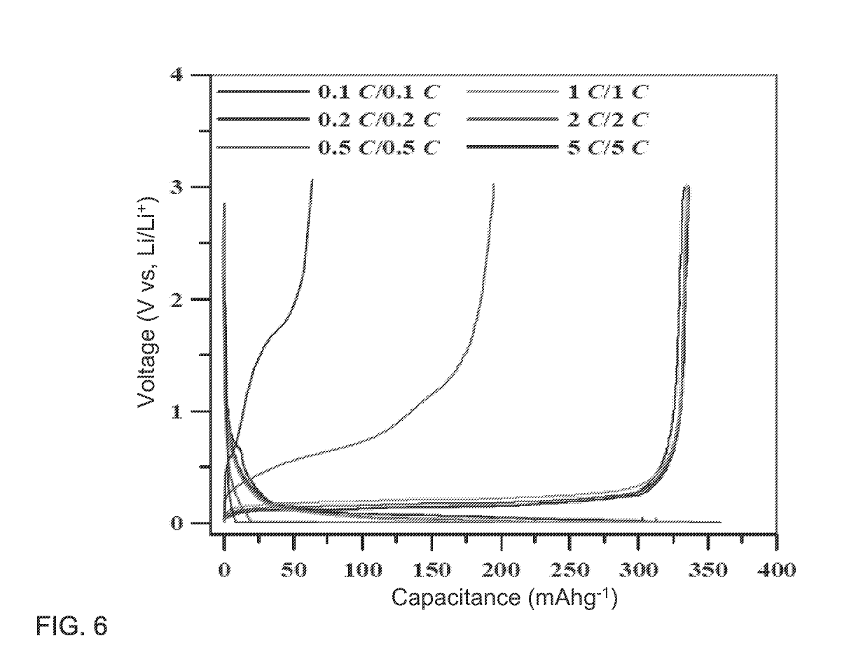

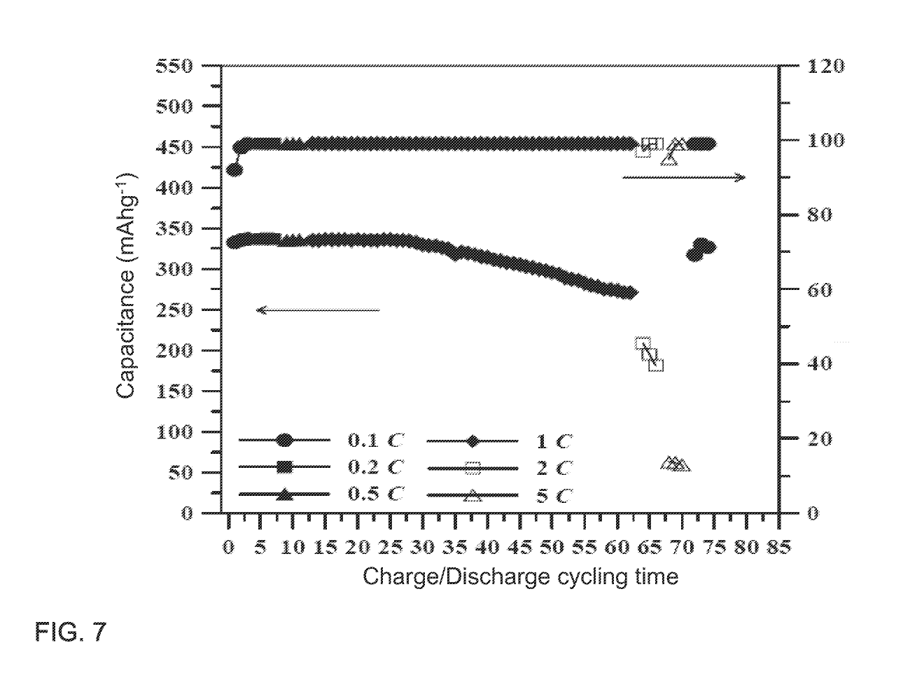

Moreover, please refer to FIG. 6 and FIG. 7, which respectively show a plot of voltage v.s. capacitance and a plot of capacitance v.s. charge/discharge cycling time of the conventional MCMBs for lithium ion rechargeable battery. Besides, the critical experiment data of FIG. 6 and FIG .7 are further listed in following Table 2.

TABLE 2

| | capacitance | coulombic efficiency |
|---|---|---|
| charge/discharge rate | (mAhg−1) | i. (%) |
| 0.1 | 332.62 | 92 |
| 0.2 | 336.68 | 99 |
| 0.5 | 335.44 | 99 |
| 1 | 335.44 | 99 |
| 2 | 208.6 | 97 |
| 5 | 63.3 | 95 |

Obviously, according to above Table 1 and Table 2, the negative electrode of the present invention reveal high performance in its capacitance and coulombic efficiency better than the capacitance and the coulombic efficiency of the MCMBs. Therefore, the experiment data proves that the capacitance characteristic of negative electrode for lithium ion rechargeable battery is greater than the conventional mesocarbon microbeads (MCMBs).

Thus, through the descriptions, the negative electrode for lithium ion rechargeable battery and the manufacturing method thereof of the present invention have been completely introduced and disclosed; Moreover, the practicability and the technology feature have also been proven by various experiment data. So that, in summary, the present invention has the following advantages

1. In the present invention, it mainly takes a vermicular graphite having high electrical conductivity and oil absorption as the material for making the negative electrode of the lithium ion rechargeable battery, so as to increase the capacitance of the negative electrode.

2. Moreover, the manufacturing method of the present invention can be used for fabricating the negative electrode of the lithium ion rechargeable battery under the conditions of reducing manufacturing cost and solvent usage, therefore the environment can be protect from the manufacturing process pollution.

The above description is made on embodiments of the present invention. However, the embodiments are not intended to limit scope of the present invention, and all equivalent implementations or alterations within the spirit of the present invention still fall within the scope of the present invention.

What is claimed is:

1. A negative electrode for lithium ion rechargeable battery, comprising:
at least one vermicular graphite, being fabricated by way of thermally treating an expandable graphite powder; and
at least one pitch, being adsorbed in the pores of the vermicular graphite;
wherein the pitch adsorbed in the vermicular graphite would be carbonized and graphitized, such that a composite graphite having multi-layer flake graphite is formed, and the composite graphite is further pulverized to a composite graphite powder.

2. The negative electrode for lithium ion rechargeable battery of claim 1, wherein the pitch is adsorbed in the pores of the vermicular graphite by a high-temperature liquid state.

3. The negative electrode for lithium ion rechargeable battery of claim 1, wherein the pitch is selected from the group consisting of: petroleum pitch, coal tar pitch, A240 petroleum pitch, and impregnation pitch.

4. The negative electrode for lithium ion rechargeable battery of claim 1, wherein the weight percentage of the vermicular graphite in the composite graphite is ranged between 0.1 wt % and 10 wt %.

5. A method for manufacturing a negative electrode for lithium ion rechargeable battery, comprising the steps of:
(1) fabricating a composite graphite powder, and sieving the composite graphite powder;
(2) uniformly mixing the sieved composite graphite powder and a conductive carbon for making a mixed powder;
(3) evenly mixing an adhesive and a solvent for fabricating a mixed solution;
(4) adding the mixed solution into the mixed powder for forming a slurry, wherein there has a specific ratio between the mixed solution and the mixed powder;
(5) coating the slurry onto a collector plate, and disposing the collector plate into a vacuum oven for executing a vacuum drying process;
(6) treating a laminating process to the collector plate;
(7) further processing the collector plate, so as to produce an electrode with appropriate size and weight; and
(8) assembling a half-cell electrode by using the electrode.

6. The method of claim 5, wherein the step (1) further comprises the detailed steps of:
(11) providing a flake graphite powder;
(12) acidifying the flake graphite powder;
(13) properly washing the acidified flake graphite powder and then drying the flake graphite powder, such that an expandable graphite powder is fabricated;
(14) thermally treating the expandable graphite powder by a specific temperature, so as to make the expandable graphite powder become a vermicular graphite;
(15) mixing the vermicular graphite and an pitch, wherein the pitch would be adsorbed into the pores of the vermicular graphite, and then be carbonized and graphitized, such that a composite graphite having multi-layer flake graphite is formed;
(16) pulverizing the composite graphite to a composite graphite powder, and then sieving the composite graphite powder according to the particle size thereof.

7. The method of claim 6, wherein the specific temperature is ranged between 700-deg C. and 1000-deg C.

8. The method of claim 5, wherein the step (5) further comprises the detailed steps of:
(51) coating the slurry onto the collector plate by using a scraper; and
(52) disposing the collector plate into vacuum oven, and executing the vacuum drying process after volatilizing the mixed solution.

9. The manufacturing method of claim 5, wherein the laminating rate of the laminating process in the step (6) is 75%.

10. The manufacturing method of claim 5, wherein an electrolyte used in the step (8) is a lithium hexafluorophosphate (LiPF₆) of 1.0 M, and the LiPF₆ is dissolved in a solution consisting of a ethylene carbonate, a polycarbonate and a dimethyl carbonate, wherein the weight percent ratio of the ethylene carbonate, the polycarbonate and the dimethyl carbonate is 1:1:1.
